(19) United States
(12) Patent Application Publication
(10) Pub. No.: US 2007/0261085 A1
(43) Pub. Date: Nov. 8, 2007

(54) Method and system for accessing programs from multiple triple play service listings

(75) Inventors: Robert J. Beaton, Apohaqui (CA); Karen Lee McKinley, Grand Bay - Westfield (CA); Jeff Furlong, Grand Bay - Westfield (CA)

Correspondence Address: KRAMER & AMADO, P.C., 1725 DUKE STREET, SUITE 240, ALEXANDRIA, VA, 22314, US

(73) Assignee: ALCATEL, Paris (FR)

(21) Appl. No.: 11/418,132

(22) Filed: May 5, 2006

(51) Int. Cl. H04N 7/173; G06F 3/00; H04N 5/445

(52) U.S. Cl. 725/87; 725/61; 725/86; 725/112

(57) ABSTRACT

A method for accessing triple play programs provided through a server over a network to a data processing system, the method comprising: receiving respective signals selecting one or more programs from respective program listings for each of one or more triple play services; composing a list of selected programs from the one or more programs; and, displaying the list of selected programs on a display screen of the data processing system, whereby a user may access one or more programs by selecting from the list of selected programs.

### FIELD OF THE INVENTION

This invention relates to triple play service, and more specifically, to a method and system for selecting content available through multiple triple play services such as television, video-on-demand, and pay-per-view.

### BACKGROUND OF THE INVENTION

In telecommunications, the term “triple play service” or “triple play” refers to the provision of three services, namely, high-speed Internet, television (i.e., video-on-demand or regular broadcasts), and telephone service, over a single broadband connection by a service provider (“SP”). Triple play service is offered by cable television operators as well as by telecommunication operators. For a telephone local exchange carrier (“LEC”), triple play service is delivered using a combination of optical fiber and digital subscriber line (“DSL”) technologies to their residential customer subscriber base. This configuration uses fiber communications to reach distant locations and uses DSL over an existing plain old telephone serve (“POTS”) twisted pair cable as last mile access to the subscriber's home. Cable television operators use a similar architecture called hybrid fibre coaxial (“HFC”) to provide subscriber homes with broadband, but use the available coaxial cable rather than a twisted pair for the last mile transmission standard. Subscriber homes can be in a residential environment, multi-dwelling units, or even in business offices.

Using DSL over twisted pair, television content is delivered using Internet Protocol (“IP”) television (“IPTV”) where the content is streamed to the subscriber in a MPEG-2 (“Moving Pictures Expert Group”-2) transport format. With IPTV, digital television service is delivered to subscribing consumers using IP over a broadband connection. On an HFC network, television may be a mixture of analog and digital television signals. A set-top-box (“STB”) is used at the subscriber's home to allow the subscriber to control viewing and order new video services such as movies on demand. Internet service is delivered via asynchronous transfer mode (“ATM”) or data over cable service interface specification (“DOCSIS”), typically provided as a 10BASE-T (i.e., 10 Mbit/s baseband over twisted pair) Ethernet port to the subscriber. Voice can be delivered using a traditional POTS interface as part of the legacy telephone network or can be delivered using voice over IP (“VoIP”). In a HFC network, voice is delivered using VoIP.

Some service providers (“SPs”) also provide Ethernet-to-the-home and fiber-to-the-home networks which support triple play service and bypass the disadvantages of adapting broadband transmission to legacy networks. This is particularly common in green field developments where capital expenditures are reduced by deploying one network to deliver all services.

Triple play has led to the term “quadruple play” where wireless communications is introduced as another media to deliver video, Internet, and voice content. Advances in both code division multiple access (“CDMA”) and global system for mobile communications (“GSM”) standards, utilizing third generation (“3G”), fourth generation (“4G”), or universal mobile telecommunications service (“UMTS”) mobile telephone technologies, allow service operators to provide quadruple play services. The grouping together of services (such as triple or quadruple play) is referred to as “multi-play”.

It has been said that the main challenges in offering triple play relate to backend processes and subscriber support. With respect to technical challenges, voice, video and high speed data all have different characteristics and place different burdens on the network that provides access to these services. For example, voice services are greatly affected by jitter, whereas packet loss or packet reordering has a greater affect on video and data services. Using a shared network resource such as cable or DSL requires that the network equipment used employs quality of service mechanisms.

With respect to subscriber support for television (“TV”), video-on-demand (“VOD”), and pay-per-view (“PPV”) triple play services, subscribers are beginning to demand improved methods for searching and accessing available programs. In particular, as TV subscribers wade through over 250 channels in their interactive TV listing guides or more than 500 movie title choices in their VOD and PPV guides, subscribers may find that although they may have identified several items that they would be interested in viewing, they have no way of remembering what they considered viewing by the time they have covered all of the content presented in the TV, VOD, or PPV guides. This problem arises, in essence, because subscribers have such a large volume of content available to them. As such, an individual subscriber is forced to remember too many channel numbers, movie titles, viewing times, and other criteria. The subscriber is forced to analyze this data in his or her head, while one purpose of TV, for example, is to help the subscriber relax. Current TV, VOD, and PPV user interfaces or guides do not provide efficient means for aiding subscribers in their selection of programs to view.

For reference, the term “pay-per-view” (“PPV”) refers to a system in which television subscribers can purchase programs (e.g., films, TV shows, sporting events, etc.) to be seen on TV and pay for the private telecast of that program to their homes later. The program is shown at the same time to all subscribers ordering it. In contrast, in a “video-on-demand” (“VOD”) system, subscribers may view the program at any time. In both PPV and VOD systems, programs can be purchased using an on-screen guide or user interface, an automated telephone system, or through a live customer service representative.

With respect to user interfaces for televisions in general, U.S. Pat. No. 6,175,362 to Harms, et al. (“Harms”), provides a TV graphical user interface for selection among various lists of TV channels. In Harms, a TV graphical user interface (“GUI”) in a satellite TV system enables users to create customized lists of TV channels. Everyday, favourite and theme lists may be generated to respectively combine TV channels being watched regularly, favourite TV channels, and channels relating to particular subjects. An oval list name object is arranged on a screen to indicate the name of the currently selected list of TV channels. The users may click on the list name object to make their selection among various TV channel lists available in the TV system. In a channel changer mode, the TV GUI displays a graphical channel changer composed of channel boxes that show numbers and logos of TV channels in the currently selected list. To switch the TV set to a required TV channel, the user clicks on the graphical channel box that indicates the required channel. In a program guide mode, a list of TV programs may be provided based on the channel changer. Vertical program bars that display TV programs are aligned with the channel boxes indicating TV channels that carry the corresponding TV programs. To identify various TV channel lists available in the TV system, the oval list name object, as well as the channel boxes and program bars, are displayed in a color that represents a selected TV channel list.

In addition, United States Patent Application Publication No. 2003/0063117 by Chang, et al. (“Chang”), provides a system and method for establishing a filtered subset of TV programming based on a viewer profile. In Chang, a removable media hub is connected or incorporated into a TV, with the hub receiving removable media that contain and store viewers' profiles. The electronic program guide of the TV or access to channels is filtered based on the profiles contained in the removable media. The programming choices can be filtered based on an analysis of the congruity (intersections, disparities, etc.) of the individual profiles which are active in the hub, giving a set of choices representing common interests of the group.

Thus, while systems such as those provided by Harms and Chang may provide pre-filtering of GUI content based on subscriber choices, they do not a provide adequate means for facilitating decision making by subscribers with respect to what programs to view from amongst the programs in the pre-filtered content. In addition, filtering based on profiles pre-limits the subscriber to viewable content that the selected content criteria dictates. As such, the subscriber is not provided with the opportunity to consider all of the available content from the television service. Furthermore, Harms and Chang do not address content selection for triple play services such as VOD and PPV.

A need therefore exists for an improved method for selecting content available through multiple triple play services such as TV, VOD, and PPV. Accordingly, a solution that addresses, at least in part, the above and other shortcomings is desired.

### SUMMARY OF THE INVENTION

According to one aspect of the invention, there is provided a method for accessing triple play programs provided through a server over a network to a data processing system, the method comprising: receiving respective signals selecting one or more programs from respective program listings for each of one or more triple play services; composing a list of selected programs from the one or more programs; and, displaying the list of selected programs on a display screen of the data processing system, whereby a user may access one or more programs by selecting from the list of selected programs.

The method may further include receiving a signal to select one or more programs from the list of selected programs for viewing. The method may further include receiving a signal to select one or more programs from the list of selected programs for recording. The method may further include receiving a signal to select one or more programs from the list of selected programs for deleting from the list. The method may further include displaying each of the respective program listings on the display screen. Each of the respective program listings and the list of selected programs may have a respective graphical user interface (“GUI”). Each GUI may include a window for displaying a program that is being currently viewed. Each GUI may include a window for displaying a description of a selected program. The signals may be generated by an input device coupled to the data processing system, the input device for manipulating by a user to position a cursor on the display screen. The data processing system may be at least one of a television (“TV”) system, a video-on-demand (“VOD”) system, and a pay-per-view (“PPV”) system. The services may include at least one of a TV service, a VOD service, and a PPV service. The one or more programs may be one or more of TV programs, VOD programs, and PPV programs. The network may be an Internet Protocol (“IP”) based network. The server may be an Internet server. And, the method may further include ordering the list of selected programs chronologically.

In accordance with further aspects of the present invention there is provided an apparatus such as a data processing system (e.g., a TV system, a VOD system, a PPV system, etc.), a method for adapting this system, as well as articles of manufacture such as a computer readable medium having program instructions recorded thereon for practising the method of the invention.

### BRIEF DESCRIPTION OF THE DRAWINGS

Further features and advantages of the embodiments of the present invention will become apparent from the following detailed description, taken in combination with the appended drawings, in which:

FIG. 1 is a block diagram illustrating a communications system for providing triple play service in accordance with an embodiment of the invention;

FIG. 2 is a block diagram illustrating a data processing system adapted to implement an embodiment of the invention;

FIG. 3 is a screen capture illustrating a TV program listing guide for highlighting programs (i.e., content) available through a triple play TV service in accordance with an embodiment of the invention;

FIG. 4 is a screen capture illustrating a VOD program guide for highlighting programs (i.e., content) available through a triple play VOD service in accordance with an embodiment of the invention;

FIG. 5 is a screen capture illustrating a selection guide for selecting previously highlighted programs (i.e., content) for present or future viewing in accordance with an embodiment of the invention; and,

FIG. 6 is a flow chart illustrating operations of modules within the memory of a data processing system for accessing triple play programs provided through a server over a network to the data processing system, in accordance with an embodiment of the invention.

It will be noted that throughout the appended drawings, like features are identified by like reference numerals.

### DETAILED DESCRIPTION OF THE PREFERRED EMBODIMENTS

In the following description, details are set forth to provide an understanding of the invention. In some instances, certain software, circuits, structures and techniques have not been described or shown in detail in order not to obscure the invention. The term “data processing system” is used herein to refer to any machine for processing data, including the television (“TV”) systems, set-top boxes, video-on-demand (“VOD”) systems, pay-per-view (“PPV”) systems, personal computers (“PCs”), servers, handheld electronic devices, personal digital assistants (“PDAs”), wireless communication devices, cellular telephones, wireless email devices (e.g., the Blackberry™), instant messaging (“IM”) devices, wired telephones, and remote controls described herein. The present invention may be implemented in any computer programming language provided that the operating system of the data processing system provides the facilities that may support the requirements of the present invention. Any limitations presented would be a result of a particular type of operating system or computer programming language and would not be a limitation of the present invention.

The present invention provides a method and system for selecting content available through triple play services, such as TV, VOD, and PPV, through a graphical user interface or guide displayed on the display screen of a data processing system ( e.g., a TV system, VOD system, PPV system, PC, PDA, etc.). In the following, the term “triple play” will refer to both “quadruple play” and “multi-play” services.

In particular, the present invention provides a guide applicable to TV, VOD, and PPV triple play services that allows a subscriber to highlight programs (or titles, content, etc.) of interest as they view a listing of programs presented by the guide. The present invention is applicable to any form of content available through triple play service such as TV, VOD, and PPV services. According to one aspect of the invention, at any point while using the guide, the subscriber can invoke a list of highlighted programs (i.e., a “maybe list”) so that the subscriber may easily view the highlighted programs, decide upon viewing particular highlighted programs, and access the programs (i.e., shows, content, movies, etc.) that the subscriber wants to view, record, rent, set a reminder for, etc., at the present, next, or in the future. The present invention provides a simple (i.e., user friendly) method to “flag” a program to make informed decision easier, a simple method to return to a program quickly (e.g., a VOD title viewed 5 minutes ago), and an aggregated list of all programs that the subscriber has indicated that they might want to view or select from.

With the present invention, a subscriber may highlight selected programs of interest from a list of programs. The highlighted programs form a “maybe list”. From the maybe list, the subscriber may then choose one or more programs to view. The user may then proceed to view or schedule for viewing, etc., the chosen programs. The maybe list is then discarded (e.g., after a predetermined period of time). A metaphor for this method would be a subscriber walking around a movie rental store, picking up and holding movies that are of interest, deciding from the held movies which to rent, putting down the movies that were not chosen, and proceeding to the checkout counter to complete the rental transaction for the chosen movies.

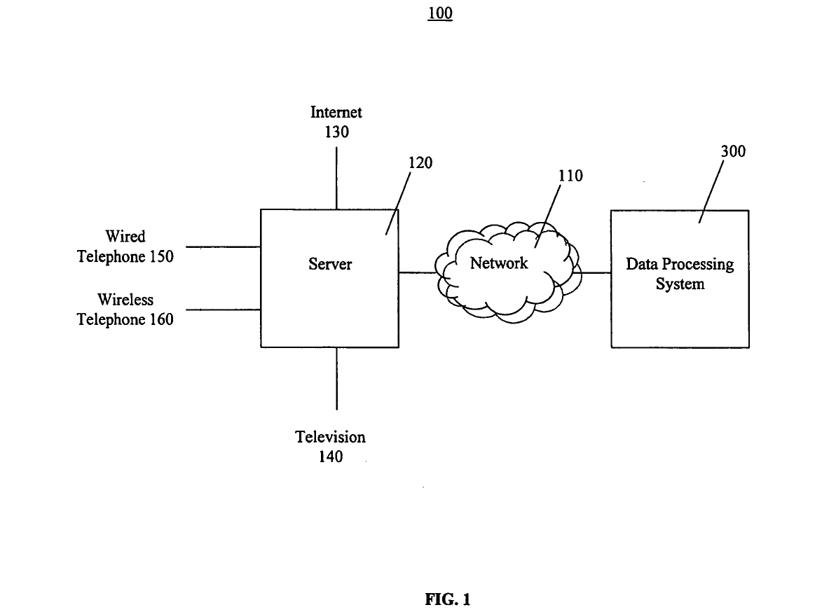

FIG. 1 is a block diagram illustrating a communications system 100 for providing triple play service in accordance with an embodiment of the invention. The communications system 100 includes a server 120 coupled to a data processing system 300 over a network 110. The server 120 may be maintained by a service provider (“SP”) to provide triple play service to a subscriber or user of the data processing system 300. The server 120 accesses Internet 130, television 140, wired telephone 150, and wireless telephone or cellular 160 networks for providing corresponding services to the data processing system 300 in accordance with control messages received from the data processing system 300 over the network. The network 110 may be an IP based network (i.e., in the case of Internet, television, and wired telephone services) and/or a wireless network (i.e., in the case of wireless telephone or cellular services). The network 110 may include routers, switches, base stations, antennae, and other network devices (not shown).

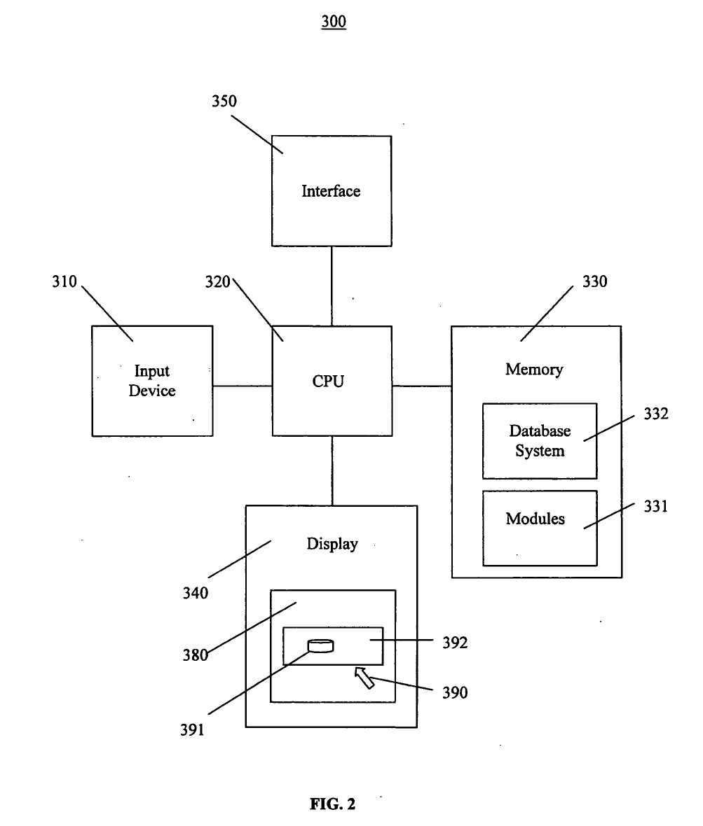

FIG. 2 is a block diagram illustrating a data processing system 300 adapted to implement an embodiment of the invention. The data processing system 300 is suitable for operation as a television (“TV”) system, a set-top box, a video-on-demand (“VOD”) system, a pay-per-view (“PPV”) system, a personal computer (“PC”), a server, a handheld electronic device, a personal digital assistant (“PDA”), a wireless communication device, a cellular telephone, a wireless email device (e.g., the Blackberry™), an instant messaging (“IM”) device, a wired telephone, and a remote control. The data processing system 300 includes a central processing unit (“CPU”) 320, memory 330, and an interface device 350 and may optionally include an input device 310 and a display 340. The CPU 320 may include dedicated coprocessors and memory devices. The memory 330 may include RAM, ROM, disk devices, and databases. The interface device 350 may include a network connection (e.g., an IP based network connection and/or a wireless network connection). The input device 310 may include a keyboard, a mouse, a trackball, a remote control unit, or a similar device. And, the display 340 may include a computer screen, television screen, terminal device, or a hardcopy producing output device such as a printer or plotter. The data processing system 300 is adapted for communicating with other data processing systems (e.g., 120) over a network 110 via the interface device 350. The data processing system 300 may include a database system 332 for storing and accessing network topology and programming information. The database system 332 may include a database management system (“DBMS”) and a database and may be stored in the memory 330 of the data processing system 300. The data processing system 300 has stored therein data representing sequences of instructions which when executed cause the method described herein to be performed. Of course, the data processing system 300 may contain additional software and hardware a description of which is not necessary for understanding the invention.

The CPU 320 of the system 300 is operatively coupled to memory 330 which stores an operating system (not shown) for general management of the system 300. The interface 350 may be used for communicating to external data processing systems (e.g., the server 120 in FIG. 1, etc.) through a network 110. The system 300 may include application server software (not shown) for developing and managing distributed applications. The CPU 320 of the system 300 is typically coupled to one or more devices 310 for receiving user commands or queries and for displaying the results of these commands or queries to the user on a display 340. As mentioned, the memory 330 may include a variety of storage devices including internal memory and external mass storage typically arranged in a hierarchy of storage as understood to those skilled in the art.

A user may interact with the data processing system 300 and its hardware and software modules 331 using a graphical user interface (“GUI”) 380. The GUI 380 may be used for monitoring, managing, and accessing the data processing system 300. GUIs are supported by common operating systems and provide a display format which enables a user to choose commands, execute application programs, manage computer files, and perform other functions by selecting pictorial representations known as icons, or items from a menu through use of an input or pointing device such as a mouse 310. In general, a GUI is used to convey information to and receive commands from users and generally includes a variety of GUI objects or controls, including icons, toolbars, drop-down menus, text, dialog boxes, buttons, and the like. A user typically interacts with a GUI 380 presented on a display 340 by using an input or pointing device (e.g., a mouse) 310 to position a pointer or cursor 390 over an object 391 and by “clicking” on the object 391.

Typically, a GUI based system presents application, system status, and other information to the user in “windows” appearing on the display 340. A window 392 is a more or less rectangular area within the display 340 in which a user may view an application or a document. Such a window 392 may be open, closed, displayed full screen, reduced to an icon, increased or reduced in size, or moved to different areas of the display 340. Multiple windows may be displayed simultaneously, such as: windows included within other windows, windows overlapping other windows, or windows tiled within the display area.

Thus, the data processing system 300 includes computer executable programmed instructions for directing the system 300 to implement the embodiments of the present invention. The programmed instructions may be embodied in one or more hardware modules or software modules 331 resident in the memory 330 of the data processing system 300. Alternatively, the programmed instructions may be embodied on a computer readable medium (such as a CD disk or floppy disk) which may be used for transporting the programmed instructions to the memory 330 of the data processing system 300. Alternatively, the programmed instructions maybe embedded in a computer-readable signal or signal-bearing medium that is uploaded to a network by a vendor or supplier of the programmed instructions, and this signal or signal-bearing medium may be downloaded through an interface (e.g., 350) to the data processing system 300 from the network by end users or potential buyers.

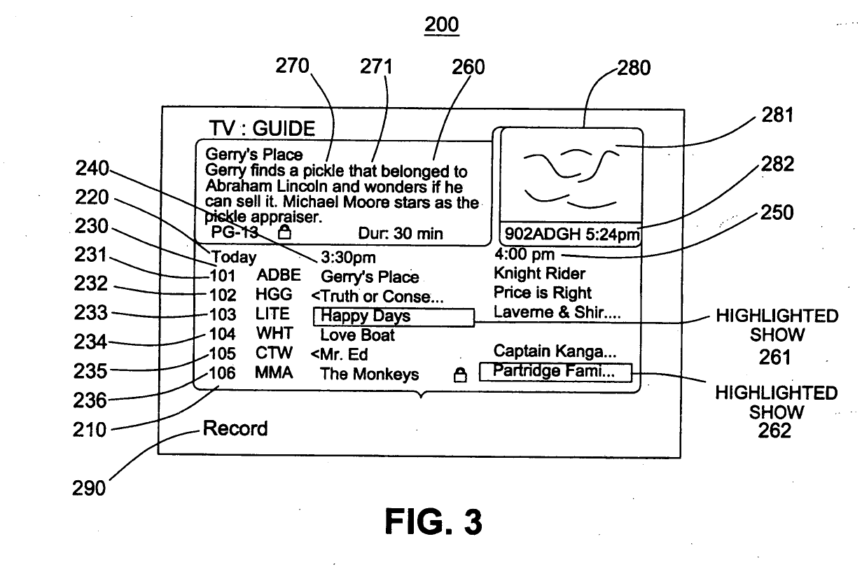

FIG. 3 is a screen capture illustrating a TV program listing guide 200 for highlighting programs (i.e., content) available through a triple play TV service in accordance with an embodiment of the invention. In FIG. 3, the guide 200 is displayed on a display screen 340 of a data processing system 300 as a part of that system's GUI 380. In this embodiment, the data processing system 300 is a TV system and the input device 310 is in the form of a remote control. The TV system 300 may communicate through its interface 350 over a network 110 to other local or remote data processing systems 120. A set-top box may function as a base system for the TV system 300 and its remote control 310.

The guide 200 provides a table or choice of programs 210 available on a given date 220. The given date is indicated by a date field 220. In FIG. 3, the value in the date field 220 is “Today”. The table 210 has a channel number column 230 (or list) followed by time slot columns 240, 250 (or lists). The table 210 has a row 231-236 for each channel. In FIG. 3, the channels are “101 ADBE” 231, “102 HGG” 232, “103 LITE” 233, “104 WHT” 234, “105 CTW” 235, and “106 MMA” 236 and the time slot columns are labelled “3:30 pm” 240 and “4:00 pm” 250. The intersection of a channel row (e.g., “101 ADBE” 231 with a time slot column (e.g., “3:30 pm” 240) gives the program (e.g., “Gerry's Place” 260) available on the respective channel 231 during the respective time slot 240. Of course, the table 210 may include additional rows and columns. These additional rows and columns may be presented on the display screen 340 through a scrolling operation, etc. The channels 231-236 in the channel column 230 may represent the channels to which the user (or subscriber) has subscribed.

The guide 200 may include a program description window 270 for displaying a description 271 of a program (e.g., “Gerry's Place” 260) in the table 210 at the current position of the cursor 390. The description 271 may include the title of the program (e.g., “Gerry's Place”), a text description of the subject or plot of the program (e.g., “Gerry finds a pickle . . . ”), a rating for the program (e.g., “PG-13”), a duration of the program (e.g., “30 min.”), etc.

The guide 200 may include a program preview window 280 for displaying a view (i.e., a picture-in-picture view) 281 of a program that the user is currently viewing. In this case, the window 280 may include a field 282 for displaying the current time and channel (e.g., “902 ADGN 5:24 pm”). Alternatively, the program preview window 280 may display a selection (e.g., a trailer) 281 from a program (e.g., “Gerry's Place” 260) in the table 210 at the current position of the cursor 390.

The user indicates programs of interest by selecting them from the table of programs 210 using the input device 310 (i.e., a remote control). The selected programs of interest are then highlighted within the table of programs 210. In FIG. 3, the user has selected “Happy Days” 261 and “Partridge Family” 262 as the user's programs of interest 261, 262. These programs 261, 262 are shown in a different colour or shade to indicate that they have been selected.

In addition, the guide 200 may include one or more function buttons for selecting to initiate various functions relating to the highlighted program or programs 261, 262. These functions may correspond to services provided by the SP. In FIG. 3, a record button 290 is shown for selecting to initiate a record (i.e., on tape or store in memory 330) function relating to one or more programs (e.g., 260) selected from the table 210. Of course, additional function buttons may be provided for initiating additional functions and services.

According to one embodiment, the remote control unit 310 may be provided with a highlight button (not shown) for pressing to select a program of interest in the table 210 for highlighting. According to another embodiment, a highlight button (not shown) may be displayed within the guide 200 for the same purpose.

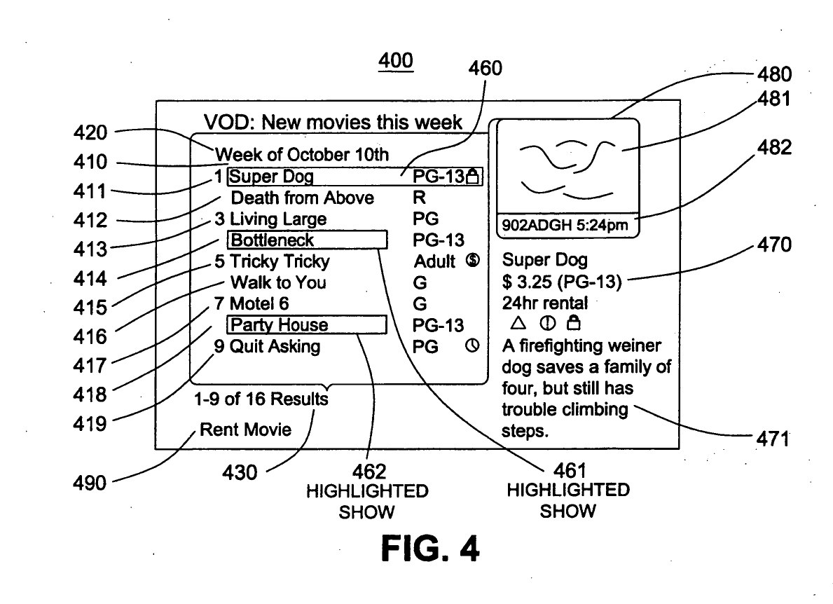

FIG. 4 is a screen capture illustrating a VOD program listing guide 400 for highlighting programs (i.e., content) available through a triple play VOD service in accordance with an embodiment of the invention. In FIG. 4, the guide 400 is displayed on a display screen 340 of a data processing system 300 as a part of that system's GUI 380. In this embodiment, the data processing system 300 is a VOD system and the input device 310 is in the form of a remote control. The VOD system 300 may communicate through its interface 350 over a network 110 to other local or remote data processing systems 120. A set-top box may function as a base system for the VOD system 300 and its remote control 310. Of course, the VOD system 300 may be collocated with a TV system 300 and/or a PPV system 300.

The guide 400 provides a list or choice of programs 410 available during a given time period 420. The given time period is indicated by a time period field 420. In FIG. 4, the value in the time period field 420 is the “Week of October 10th”. Of course, the time period field 220 may contain a specific date (e.g., “Today”). Each item 411-419 in the list 410 represents a VOD program. In FIG. 4, the programs are “Supper Dog” 411, “Death from Above” 412, “Living Large” 413, “Bottleneck” 414, “Tricky Tricky” 415, “Walk to You” 416, “Motel 6” 417, “Party House” 418, and “Quit Asking” 419. For each program 411-419, the list 410 may include a program number (e.g., “1”, “2”, “3”, etc.), a rating (e.g., “PG-13”, “R”, “PG”, etc.), and a status or access identifier (e.g., lock symbol, $ symbol, clock symbol, etc.). Of course, the list 410 may include additional programs. These additional programs may be indicated by a program number indicator field 430. In FIG. 4, the value in the program number indicator field is “1-9 of 16 results”. Programs 1-9 411-419 are presently displayed on the display screen 340. Additional programs 10-16 may be presented on the display screen 340 through a scrolling operation, etc. The programs 411-419 in the list 410 may represent the VOD service to which the user (or subscriber) has subscribed.

The guide 400 may include a program description window or field 470 for displaying a description 471 of a program (e.g., “Super Dog” 460) in the list 410 at the current position of the cursor 390. The description 471 may include the title of the program (e.g., “Super Dog”), a text description of the subject or plot of the program (e.g., “A firefighting wiener dog . . . ”), a rating for the program (e.g., “PG-13”), a price for program (e.g., “$3.25”), a duration of the rental (e.g., “24 hr rental”), etc.

The guide 400 may include a program preview window 480 for displaying a view (i.e., a picture-in-picture view) 481 of a program that the user is currently viewing. In this case, the window 480 may include a field 482 for displaying the current time and channel (e.g., “902 ADGN 5:24 pm”). Alternatively, the program preview window 480 may display a selection (e.g., a trailer) 481 from a program (e.g., “Super Dog” 460) in the list 410 at the current position of the cursor 390.

The user indicates programs of interest by selecting them from the list of programs 410 using the input device 310 (i.e., a remote control). The selected programs of interest are then highlighted within the list of programs 410. In FIG. 4, the user has selected “Bottleneck” 461 and “Party House” 462 as the user's programs of interest 461, 462. These programs 461, 462 are shown in a different colour or shade to indicate that they have been selected.

In addition, the guide 400 may include one or more function buttons for selecting to initiate various functions relating to the highlighted program or programs 461, 462. These functions may correspond to services provided by the SP. In FIG. 4, a rent movie button 490 is shown for selecting to initiate a rent function relating to one or more programs (e.g., 460) selected from the list 410. Of course, additional function buttons may be provided for initiating additional functions and services.

According to one embodiment, the remote control unit 310 may be provided with a highlight button (not shown) for pressing to select a program of interest in the list 410 for highlighting. According to another embodiment, a highlight button (not shown) may be displayed within the guide 400 for the same purpose.

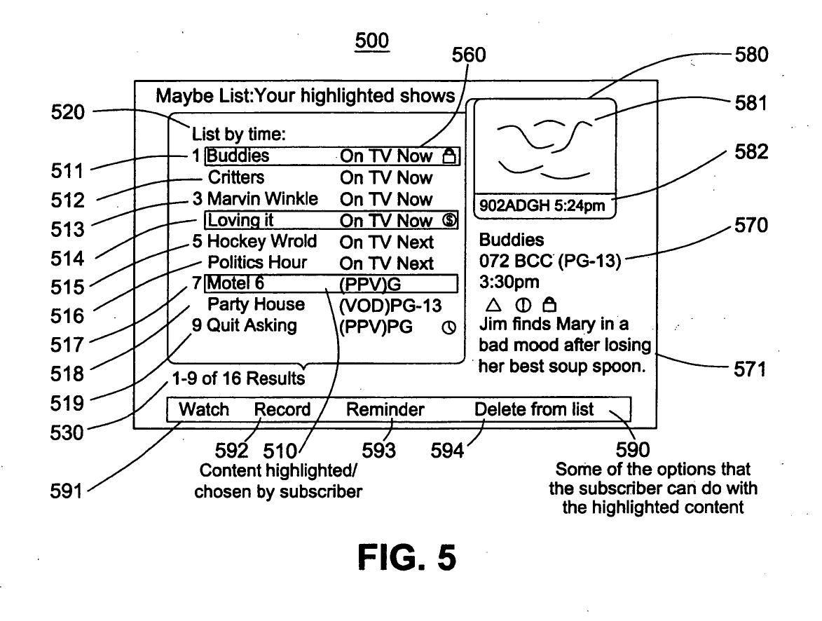

FIG. 5 is a screen capture illustrating a selection guide 500 for selecting previously highlighted programs (i.e., content) for present or future viewing in accordance with an embodiment of the invention. In FIG. 5, the guide 500 is displayed on a display screen 340 of a data processing system 300 as a part of that system's GUI 380. In this embodiment, the data processing system 300 is a combined TV, VOD, and PPV system and the input device 310 is in the form of a remote control. The system 300 may communicate through its interface 350 over a network 110 to other local or remote data processing systems 120. A set-top box may function as a base system for the system 300 and its remote control 310.

The guide 500 provides a list or choice of previously highlighted programs 510. Thus, the list 510 represents programs that the user “may” choose to view. As such, the list will be referred to a “maybe list” in the following. The maybe list 510 contains the highlighted programs 261, 262,461, 462 from the TV and VOD (and PPV) guides 200, 400. The programs in the maybe list 510 may be sorted in a variety of ways as indicated by the sort field 520. In FIG. 5, the value in the sort field 520 is “List by time” (i.e., chronologically). Of course, the soft field 520 may contain other sort criteria (i.e., by price, by service, etc.). As mentioned, each item 511-519 in the list 510 represents a TV, VOD, or PPV program that the user has previously highlighted. In FIG. 5, the programs are “Buddies” 511, “Critters” 512, “Marvin Winkle” 513, “Loving It” 514, “Hockey World” 515, “Politics Hour” 516, “Motel 6” 517, “Party House” 518, and “Quit Asking” 519. For each program 511-519, the list 510 may include a program number (e.g., “1”, “2”, “3”, etc.), a rating (e.g., “G”, “PG-13”, “PG”, etc.), a service identifier (e.g., “TV”, “PPV”, “VOD”, etc.), a status or access identifier (e.g., lock symbol, $ symbol, clock symbol, etc.), and a scheduling identifier (e.g., “On TV Now”, “On TV Next”, etc.). Of course, the list 510 may include additional programs. These additional programs may be indicated by a program number indicator field 530. In FIG. 5, the value in the program number indicator field is “1-9 of 16 results”. Programs 1-9 511-519 are presently displayed on the display screen 340. Additional programs 10-16 may be presented on the display screen 340 through a scrolling operation, etc.

The guide 500 may include a program description window or field 570 for displaying a description 571 of a program (e.g., “Buddies” 560) in the list 510 at the current position of the cursor 390. The description 571 may include the title of the program (e.g., “Buddies”), a text description of the subject or plot of the program (e.g., “Jim finds Mary in a bad mood . . . ”), a rating for the program (e.g., “PG-13”), a channel for the program (e.g., “072 BCC”), and a start time for program (e.g., “3:30 pm”), etc. The program “Buddies” 560 in FIG. 5 is a TV program. The content of the description 571 will change depending on the type of program (e.g., TV, VOD, PPV) at the current position of the cursor 390.

The guide 500 may include a program preview window 580 for displaying a view (i.e., a picture-in-picture view) 581 of a program that the user is currently viewing. In this case, the window 580 may include a field 582 for displaying the current time and channel (e.g., “902 ADGN 5:24 pm”). Alternatively, the program preview window 580 may display a selection (e.g., a trailer) 581 from a program (e.g., “Buddies” 560) in the list 510 at the current position of the cursor 390.

The user indicates one or more programs that the user wishes to view by selecting them from the maybe list 510 using the input device 310 (i.e., a remote control). The selected programs (e.g., 560) may be shown in a different colour or shade to indicate that they have been selected.

In addition, the guide 500 may include one or more function buttons 590 for selecting to initiate various functions relating to the selected program or programs 560. These functions may correspond to services provided by the SP. In FIG. 5, a watch button 591 is shown for selecting to initiate viewing of the selected program (e.g., 460), a record button 592 is shown for selecting to initiate recording (i.e., on tape or by storage in memory 330) of the selected program, a reminder button 593 is shown for selecting to initiate the posting of a reminder with respect to the selected program, and a delete button 594 is shown for selecting to initiate the deletion of the selected program from the maybe list 510. Of course, additional function buttons may be provided for initiating additional functions and services.

According to one embodiment, the remote control unit 310 may be provided with a select button (not shown) for pressing to select a program from the maybe list 510. According to another embodiment, a select button (not shown) may be displayed within the guide 500 for the same purpose.

According to one embodiment, the remote control unit 310 maybe provided with a maybe list button (not shown) for pressing to present the selection guide 500 and maybe list 510. According to another embodiment, a maybe list button (not shown) may be displayed within the TV guide 200, VOD guide 400, or other screen.

By selecting a program 511-519 from the maybe list 510, the user may view (or record, post a reminder, etc.) the selected program (e.g., 560). An appropriate message may then be sent from the data processing system 300 to the server 120 over the network 110. The messages may consist of one or more IP packets (i.e., for an IP based network) and may include an ID (i.e., a user ID, a data processing system ID, etc.) and a password for the user. Upon receiving the message, the server 120 configures or controls the TV, VOD, or PPV service as necessary and in accordance with parameters contained in the message to provide the selected program (e.g., 560) to the user's system 300.

According to one embodiment, a user may selected programs using a data processing system (e.g., a portable device 300) other than that on which the program will be viewed. In this case, the data processing system on which the program is viewed may be referred to as the target system. For example, a parent may log-in to the server 120 using a portable device 300 while at his or her workplace. The parent may then select programs to be provided to a television (i.e., the target system) at the parent's home. Thus, the parent may remotely select programs to be viewed by his or her children using a portable device 300.

The present invention provides several advantages. The maybe list 510 and deletions from this list provides subscriber viewing behaviour information that may be used by SPs and content providers for marketing purposes. This information may be used by SPs to build content and profile data which may be marketed to advertisers and content owners. The present invention provides subscribers with a method to pluck items presented in TV (or IPTV), VOD, PPV, and other content portals that interests them without committing to viewing or purchasing these items. It allows subscribers to make informed viewing decisions based on a list of chosen viewing possibilities (i.e., the maybe list 510) instead of trying to remember all the possibilities themselves. And, the present invention my lead to increases in VOD and PPV purchases since it decreases the barriers and complexity subscribers face when they need to “re-find” the programs (or content) that had peaked their interest earlier (i.e., the fewer the barriers to purchase, the greater the number of impulse purchases).

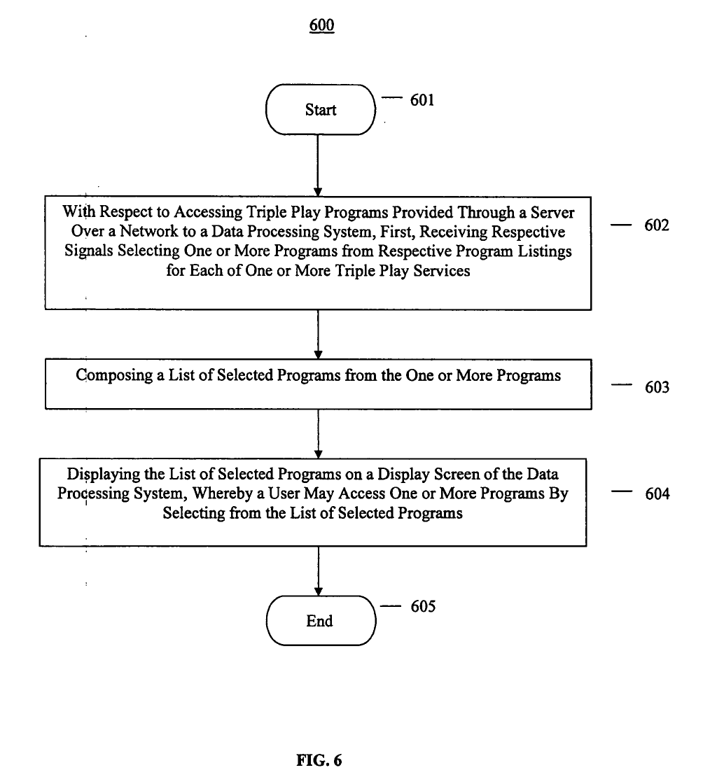

The above described method may be summarized with the aid of a flowchart. FIG. 6 is a flow chart illustrating operations 600 of modules 331 within the memory 330 of a data processing system 300 for accessing triple play programs provided through a server 120 over a network 110 to the data processing system 300, in accordance with an embodiment of the invention.

At step 601, the operations 600 start.

At step 602, respective signals selecting one or more programs 261, 262, 461, 462 from respective program listings 210, 410 for each of one or more triple play services are received.

At step 603, a list of selected programs 510 is composed from the one or more programs 261, 262, 461, 462.

At step 604, the list of selected programs 510 is displayed on a display screen 340 of the data processing system 300, whereby a user may access one or more programs 511-519 by selecting from the list of selected programs 510.

At step 605, the operations 600 end.

The method may further include receiving a signal to select 591 one or more programs (e.g., 511) from the list of selected programs 510 for viewing. The method may further include receiving a signal to select 592 one or more programs (e.g., 511) from the list of selected programs 510 for recording. The method may further include receiving a signal to select 593 one or more programs (e.g., 511) from the list of selected programs 510 for deleting from the list 510. The method may further include displaying each of the respective program listings 210, 410 on the display screen 340. Each of the respective program listings 210, 410 and the list of selected programs 510 may have a respective graphical user interface (“GUI”) 200, 400, 500. Each GUI 200, 400, 500 may include a window 280, 480, 580 for displaying a program 281, 481, 581 that is being currently viewed. Each GUI 200, 400, 500 may include a window 270, 470, 570 for displaying a description 271, 471, 571 of a selected program. The signals may be generated by an input device 310 coupled to the data processing system 300, the input device 310 for manipulating by a user to position a cursor 390 on the display screen 340. The data processing system 300 may be at least one of a television (“TV”) system, a video-on-demand (“VOD”) system, and a pay-per-view (“PPV”) system. The services may include at least one of a TV service, a VOD service, and a PPV service. The one or more programs 261, 262, 461, 462 may be one or more of TV programs, VOD programs, and PPV programs. The network 110 may be an Internet Protocol (“IP”) based network. The server 120 may be an Internet server. And, the method may further include ordering the list of selected programs 510 chronologically.

According to one embodiment of the invention, the above described method may be implemented by the server 120 rather than by the data processing system 300.

While this invention is primarily discussed as a method, a person of ordinary skill in the art will understand that the apparatus discussed above with reference to a data processing system 300, may be programmed to enable the practice of the method of the invention. Moreover, an article of manufacture for use with a data processing system 300, such as a pre-recorded storage device or other similar computer readable medium including program instructions recorded thereon, may direct the data processing system 300 to facilitate the practice of the method of the invention. It is understood that such apparatus and articles of manufacture also come within the scope of the invention.

In particular, the sequences of instructions which when executed cause the method described herein to be performed by the data processing system 300 of FIG. 2 can be contained in a data carrier product according to one embodiment of the invention. This data carrier product can be loaded into and run by the data processing system 300 of FIG. 2. In addition, the sequences of instructions which when executed cause the method described herein to be performed by the data processing system 300 of FIG. 2 can be contained in a computer software product according to one embodiment of the invention. This computer software product can be loaded into and run by the data processing system 300 of FIG. 2. Moreover, the sequences of instructions which when executed cause the method described herein to be performed by the data processing system 300 of FIG. 2 can be contained in an integrated circuit product (e.g., hardware modules) including a coprocessor or memory according to one embodiment of the invention. This integrated circuit product can be installed in the data processing system 300 of FIG. 2.

The embodiments of the invention described above are intended to be exemplary only. Those skilled in this art will understand that various modifications of detail may be made to these embodiments, all of which come within the scope of the invention.

What is claimed is:

1. A method for accessing triple play programs provided through a server over a network to a data processing system, the method comprising:
receiving respective signals selecting one or more programs from respective program listings for each of one or more triple play services;
composing a list of selected programs from the one or more programs; and,
displaying the list of selected programs on a display screen of the data processing system,
whereby a user may access one or more programs by selecting from the list of selected programs.

2. The method of claim 1 and further comprising receiving a signal to select one or more programs from the list of selected programs for viewing.

3. The method of claim 1 and further comprising receiving a signal to select one or more programs from the list of selected programs for recording.

4. The method of claim 1 and further comprising receiving a signal to select one or more programs from the list of selected programs for deleting from the list.

5. The method of claim 1 and further comprising displaying each of the respective program listings on the display screen.

6. The method of claim 5 wherein each of the respective program listings and the list of selected programs has a respective graphical user interface (“GUI”).

7. The method of claim 6 wherein each GUI includes a window for displaying a program that is being currently viewed.

8. The method of claim 7 wherein each GUI includes a window for displaying a description of a selected program.

9. The method of claim 8 wherein the signals are generated by an input device coupled to the data processing system, the input device for manipulating by a user to position a cursor on the display screen.

10. The method of claim 1 wherein the data processing system is at least one of television (“TV”) system, a video-on-demand (“VOD”) system, and a pay-per-view (“PPV”) system.

11. The method of claim 10 wherein the services include at least one of a TV service, a VOD service, and a PPV service.

12. The method of claim 11 wherein the one or more programs are one or more of TV programs, VOD programs, and PPV programs.

13. The method of claim 1 wherein the network is an Internet Protocol (“IP”) based network.

14. The method of claim 13 wherein the server is an Internet server.

15. The method of claim 1 and further comprising ordering the list of selected programs chronologically.

16. A system for accessing triple play programs provided through a server over a network to the system, the system comprising:
a processor coupled to memory, a display screen, and an input device; and,
modules within the memory and executed by the processor, the modules including:
a module for receiving respective signals selecting one or more programs from respective program listings for each of one or more triple play services;
a module for composing a list of selected programs from the one or more programs; and,
a module for displaying the list of selected programs on a display screen of the data processing system, whereby a user may access one or more programs by selecting from the list of selected programs.

17. The system of claim 16 and further comprising a module for receiving a signal to select one or more programs from the list of selected programs for viewing.

18. The system of claim 16 and further comprising a module for receiving a signal to select one or more programs from the list of selected programs for recording.

19. The system of claim 16 and further comprising a module for receiving a signal to select one or more programs from the list of selected programs for deleting from the list.

20. The system of claim 16 and further comprising a module for displaying each of the respective program listings on the display screen.

21. The system of claim 20 wherein each of the respective program listings and the list of selected programs has a respective graphical user interface (“GUI”).

22. The system of claim 21 wherein each GUI includes a window for displaying a program that is being currently viewed.

23. The system of claim 22 wherein each GUI includes a window for displaying a description of a selected program.

24. The system of claim 23 wherein the signals are generated by an input device coupled to the data processing system, the input device for manipulating by a user to position a cursor on the display screen.

25. The system of claim 16 wherein the data processing system is at least one of television (“TV”) system, a video-on-demand (“VOD”) system, and a pay-per-view (“PPV”) system.

26. The system of claim 25 wherein the services include at least one of a TV service, a VOD service, and a PPV service.

27. The system of claim 26 wherein the one or more programs are one or more of TV programs, VOD programs, and PPV programs.

28. The system of claim 16 wherein the network is an Internet Protocol (“IP”) based network.

29. The system of claim 28 wherein the server is an Internet server.

30. The system of claim 16 and further comprising a module for ordering the list of selected programs chronologically.
